(19) United States
(12) Patent Application Publication
(10) Pub. No.: US 2025/0148413 A1
(43) Pub. Date: May 8, 2025

(54) Cellular System for Bills of Lading Processing

(71) Applicant: DDC Holdings, LLC, Evergreen, CO (US)

(72) Inventor: Jan Trevalyan, Ormskirk, West Lancs (GB)

(21) Appl. No.: 18/730,255

(22) PCT Filed: Jan. 4, 2023
(86) PCT No.: PCT/US2023/010104

§ 371 Date: Jul. 18, 2024

Related U.S. Application Data
(60) Provisional application No. 63/300,493, filed on Jan. 18, 2022.

(51) Int. Cl. G06Q 10/083; G06K 7/14; G06V 10/776; G06V 10/94; G06V 30/142; G06V 30/146; G06V 30/148; G06V 30/19; G06V 30/414; G06V 30/42

(52) U.S. Cl. CPC G06Q 10/0838; G06V 10/776; G06V 10/945; G06V 30/1426; G06V 30/1475; G06V 30/153; G06V 30/1916; G06V 30/414; G06V 30/42; G06K 7/1413; G06V 2201/10

(57) ABSTRACT

In a method for a user to process a BOL (122) using an app on a cell phone (120) that includes a camera, a barcode on the BOL (122) is imaged with the camera and a data box is populated with information from the BOL (122). An indication is displayed to the user indicating what the app has determined to be the boundaries of the BOL (122). The user indicates when the BOL is within the boundaries and that the BOL (122) is within a predetermined range. An image of the BOL (122) is captured and the captured image of the BOL is displayed to the user. Upon receiving input from the user indicating that the captured image is acceptable, the captured image is analyzed so as to recognize text therein and captured text is assigned to data fields. The data fields are transmitted to a cloud-based server (10).

### BACKGROUND OF THE INVENTION

### 1. Field of the Invention

The present invention relates to shipping goods and, more specifically, to a method and system for capturing bills of lading in association with the shipping of goods.

### 2. Description of the Related Art

A bill of lading (BOL) is a document issued by a carrier (or a carrier's agent) to acknowledge receipt of cargo for shipment once the goods have been loaded onto the vessel. This receipt can be used as proof of shipment for customs and insurance purposes, and also as commercial proof of completing a contractual obligation. Bills of lading are one of three crucial documents used in international trade to ensure that exporters receive payment and importers receive the merchandise. The other two documents include an insurance policy and an invoice. A bill of lading serves three main functions, including: Acting as an acknowledgement that the goods have been loaded; evidencing the terms of the contract of carriage; and documenting title to the goods.

In the trucking industry, a truck driver will typically receive a copy of the BOL upon receipt of the goods being shipped. The copy of the BOL is usually printed on paper. The trucker will carry several loads between several different locations and at each stop the trucker will receive a different BOL. Thus, the trucker can accumulate several different BOLs between visits to a hauling company depot, at which the BOLs are transferred to a company administrator for processing. However, BOLs are occasionally lost and pages from one BOL can become accidentally interleaved with pages of another BOL. This can cause confusion when trying to organizing the BOLs and reconciling them with customer shipping orders. Additionally, delay in delivering a BOL can cause delays in responding to customer questions.

Therefore, there is a need for system for capturing a bill of lading upon receipt and transferring it quickly to a shipping company administrator.

### SUMMARY OF THE INVENTION

The disadvantages of the prior art are overcome by the present invention which, in one aspect, is a method for a user to process a bill of lading (BOL) using a an app on a cell phone that includes a camera, in which a barcode on the BOL is imaged with the camera and a data box is populated with information from the BOL. The camera is aimed at the BOL. An indication is displayed to the user indicating what the app has determined to be the boundaries of the BOL. Input is received from the user indicating that the BOL is within the indicated boundaries and that the BOL is within a predetermined range of the camera. An image of the BOL is captured and the captured image of the BOL is displayed to the user. Upon receiving input from the user indicating that the captured image is acceptable, the captured image is analyzed so as to recognize text therein and captured text is assigned to data fields. The data fields are transmitted to a cloud-based server.

In another aspect, the invention is a system for a user to process a bill of lading (BOL), including a cellular telephone including a screen, a camera and an app, and a cloud-based server. The app programmed to: image a barcode on the BOL with the camera and populate a data box with information from the BOL; indicate to the user what the app has determined to be the boundaries of the BOL; receive input from the user that the BOL is within the indicated boundaries and that the BOL is within a predetermined range of the camera; after the input has been received from the user, capture an image of the BOL and display the captured image of the BOL to the user; and after input has been received from the user indicating that the captured image is acceptable, then analyze the captured image so as to recognize text therein and assign captured text to data fields. The data fields are transmitted to the cloud-based server.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram showing one aspect of a bill of lading processing system.

FIGS. 2A-2M are screen shots demonstrating one embodiment of the bill of lading processing system.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet.

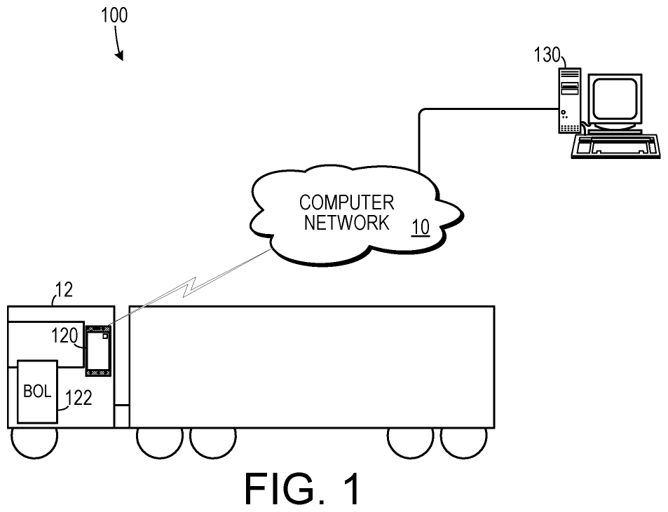

As shown in FIG. 1, one representative embodiment of a bill of lading (BOL) processing system 100 in which a truck 12 driver receives a BOL 122 and captures an image of it with a cell phone 120 camera. An app on the cell phone 120 processes the image and transmits it via a cellular network to the “cloud” 10. A shipping administrator 130 can access the BOL via resident in the global computer network 10.

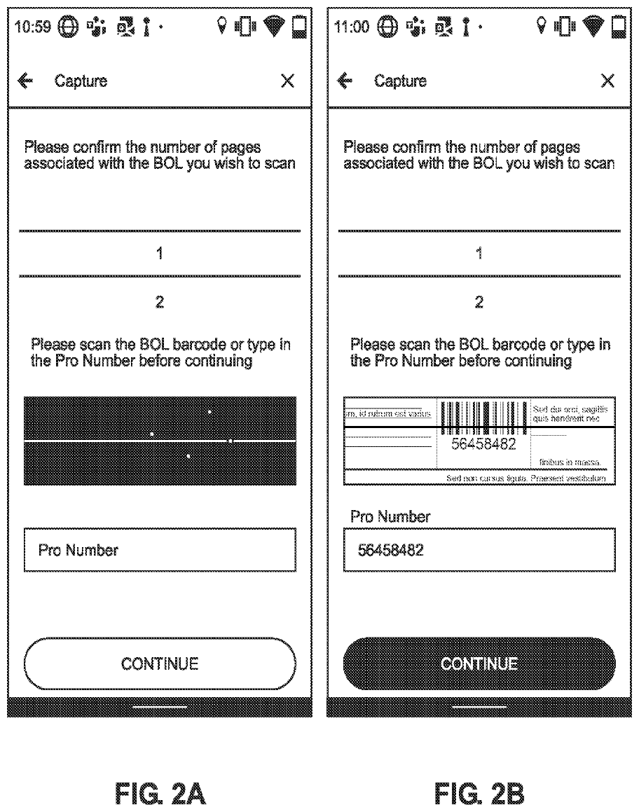

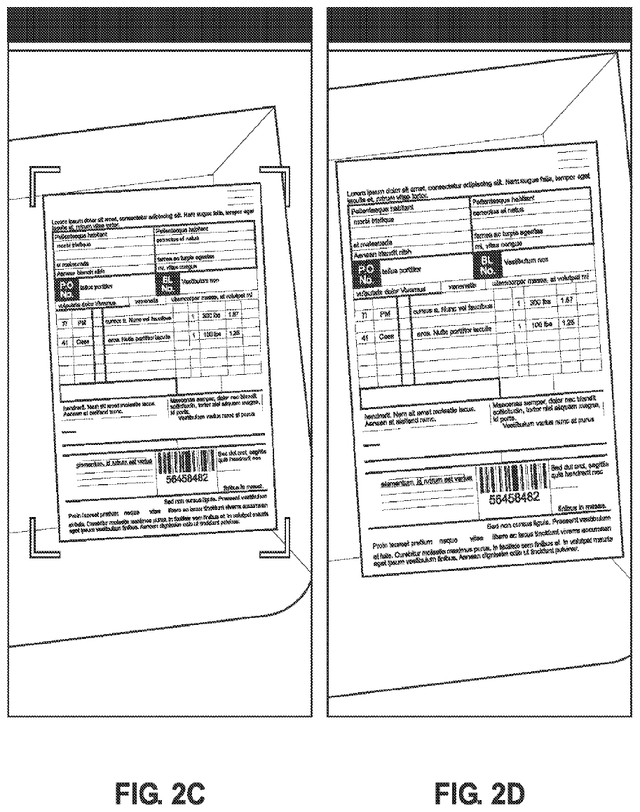

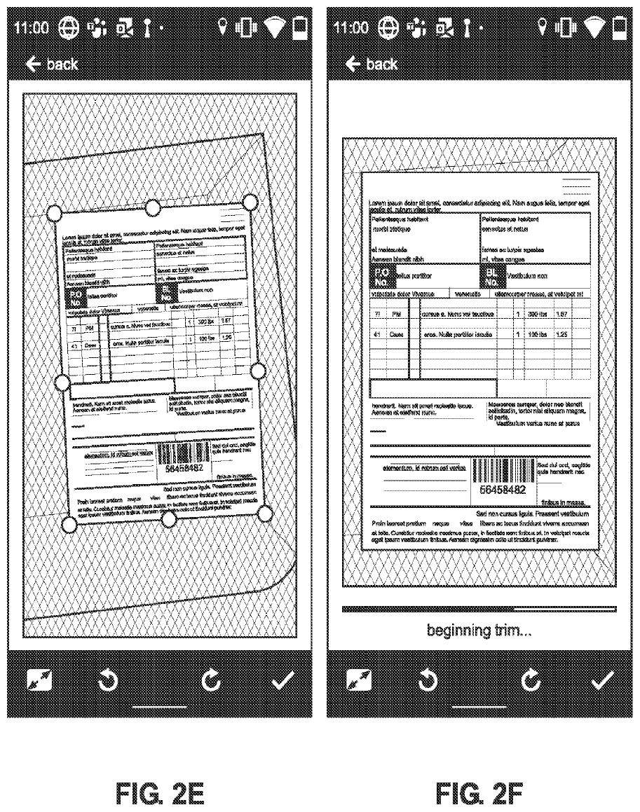

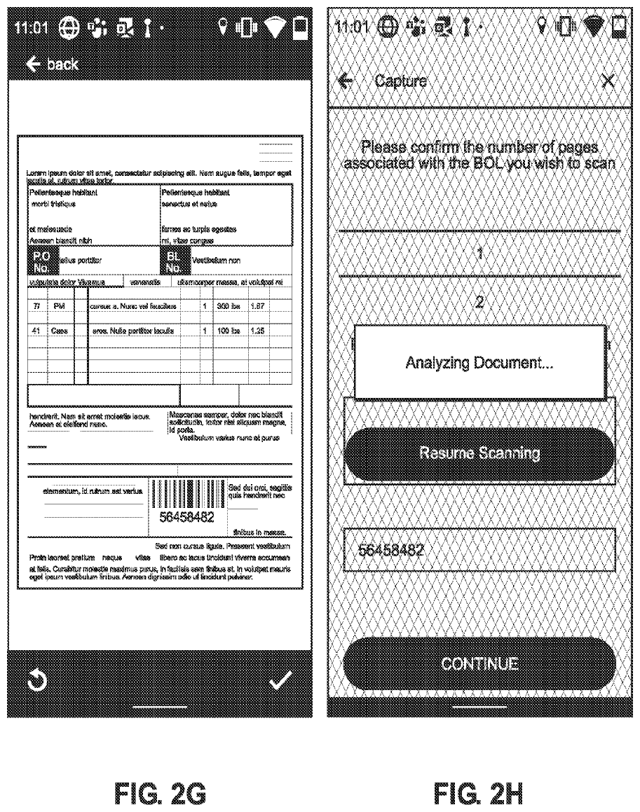

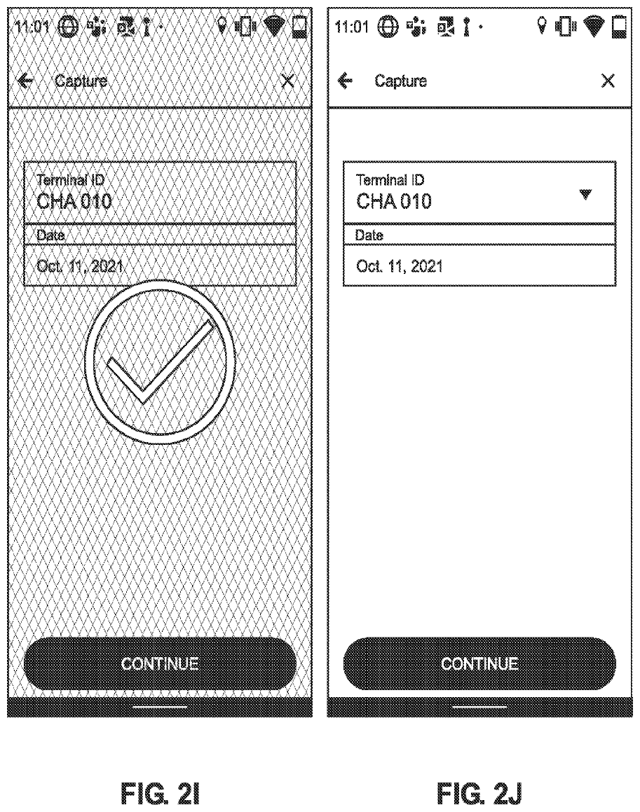

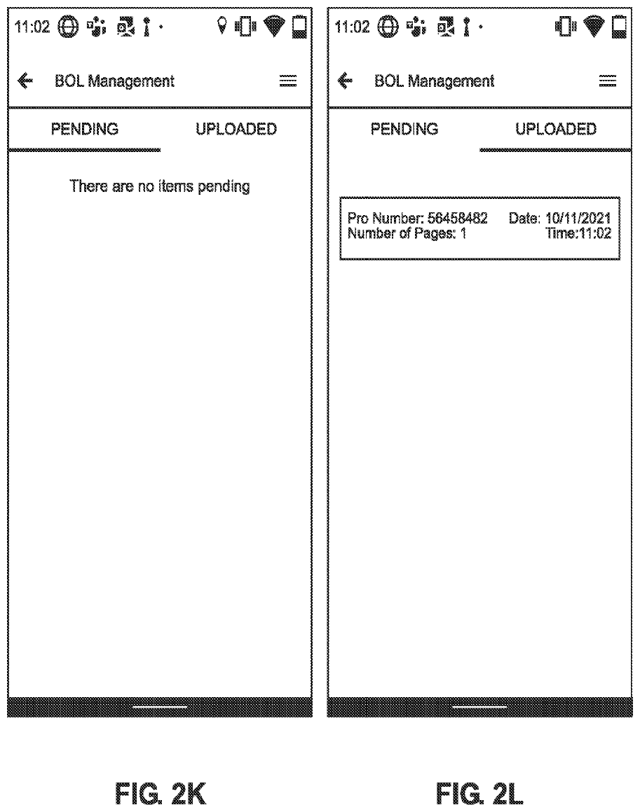

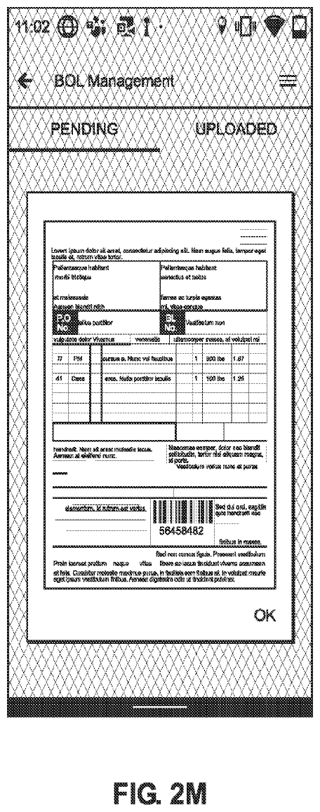

As shown in FIG. 2A, when the driver clicks on the BOL Capture button from Home Screen of the driver's cell phone, the driver is taken to the first capture screen to begin the capture process. The driver initially confirms the number of pages that are associated with the Bill of Lading by using the sliding number menu. In one commercial embodiment, the user is given the option to select up to 10 pages of Bills of Lading. This can be configured to allow for more should the shipping company desire more.

As shown in FIG. 2B, the driver holds the cell phone above the barcode on the Bill of Lading so that the barcode in the BOL is aligned with the center line of the barcode scanner. As a result, the PRO number from the BOL is then auto-populated into the grey box at the bottom of the screen. A PRO number is assigned to a shipment by the shipping provider that is responsible for moving the shipment. The PRO number is unique to a shipment. It is used to track and report on the shipment status and to identify the shipment on the shipping provider's invoice. A PRO number is assigned to a shipment by the shipping provider that is responsible for moving the shipment. The PRO number is unique to a shipment. It is used to track and report on the shipment status and to identify the shipment on the shipping provider's invoice. A shipment's PRO number will appear on its BOL. The PRO will appear on the BOL when the BOL is printed if it was available at that time. If not, the shipping provider will affix a sticker to the BOL that contains the PRO number. The sticker will be added to the BOL at the pickup location or the pickup terminal, depending on the shipping provider's process in these cases.

Should there be an issue with the auto-population of the PRO number, the driver can also manually enter the PRO number, but this must be done twice to reduce key entry errors. Once the PRO number has been populated—automatically or manually—the driver clicks continue to move on to the Capture process. The system can also be configured for pre-fixes or check digits of the PRO number. The app can also exclude particular numbers in the sequence if required.

As shown in FIG. 2C, the driver then aims the cell phone camera at the BOL. The app does not allow the driver to capture an image manually, but instead the driver must follow a process in order for the app to capture the image of a Bill of Lading. In the process, two borders appear on the camera screen. The green rectangular border is an “augmented reality” border, which detects what the app thinks resembles a Bill of Lading to ensure that the user is taking a relevant image. The blue four corners border is a “depth control” or “quality control” border that ensures that the driver is taking an image at the optimum distance from the Bill of Lading. This is a distance that was tested and found to result in the fewest number of rejections. In one commercial embodiment, this distance is in the range of 16 in. to 18 in. between the cell phone and the physical BOL document.

As shown in FIG. 2D, to capture an image, the driver must touch one part of the green border one part of the blue border, thereby indicating that the driver believes that the BOL in in the correct place and distance for imaging. Once this happens, the app auto-captures the image. The app optimizes the hardware using lighting, contrast and focus before auto-capturing the best image possible.

As shown in FIG. 2E, the app crops the image and white sliders outline the app's first pass at cropping the image so as to include just relevant information (i.e., only the BOL). The image that has been captured is bigger than the viewing point shown to the driver when aligning the borders for capture. This ensures that the document has been fully captured so as to lead to fewer errors during the capture process. The crop process allows the driver to remove any foreign objects. Conveniently, the app allows the driver to make a quick edit as opposed to being forced to re-capture the image. If the driver is left with foreign objects within the white sliders, the driver can crop these out manually. It should be noted that the screen/camera capture size is smaller in FIG. 2D as compared to FIG. 2E to help ensure the entire BOL is captured consistently each time.

As shown in FIG. 2F, the image is then cropped, de-skewed and rotated by the app to generate images of a quality equivalent to those from a terminal flat-bed scanner. If the driver is satisfied with the quality of the image and that all relevant information is included within the cropping boundaries, then the driver clicks on a check mark in the bottom right-hand corner if the screen.

As shown in FIG. 2G, the driver is then left with a thumbnail of what will be sent off for processing. The user clicks on the check-mark in the bottom right-hand corner again to continue to the OCR process.

As show in FIG. 2H, the image is then put through a local OCR tool built into the device. The app employs a local, light OCR engine to check for the quality of a capture without any delay and allow a driver to re-capture an image if necessary, irrespective of whether a data network is available. The OCR engine completes two passes against the scanned document. The first identifies the number of recognizable characters on the page. The second pass attempts to identify if the characters are known characters that are included in a known character data set. The app then generates a competency score based on the number of characters it can identify as belonging to the know character data set.

As shown in FIG. 2I, the system has the ability to manually set a competency score for each client in the back end of the system. Once the competency score is set, if the app determines that the image passes a threshold for this score and the image is deemed legible, a large check-mark appears in the middle of the screen. If the competency score is below the threshold or if the image is otherwise illegible, then the driver will be asked to re-capture the image.

When the driver has opted to scan multiple pages—and where the first image is accepted by the OCR process—the driver will here be required to return to the capture screen to take subsequent images for BOLs that include more than one page. The driver is required to repeat this loop for every page has been indicated at the start of the process so that a page count is created to further increase accuracy of the app.

As show in FIG. 2J, the driver will then be asked to put a designated terminal in the Terminal ID box. This box can be pre-populated with the driver's designated terminal. The driver can change this by selecting another terminal from a drop-down list. The date will be greyed out to indicate that it is prepopulated and cannot be changed by the driver. By clicking continue at this point, the driver submits the BOL for processing.

As shown in FIG. 2K, the driver can display a BOL Management screen, which provides BOL management information stored on the cloud server. Generally, there should never be any submitted BOLs in the “Pending” tab, except for when a driver does not have cell reception and the BOL has been successfully processed by the built-in OCR tool and is waiting for network re-connection to be uploaded to the cloud. This is an automatic process and there is no need for driver input once the cell phone has achieved cell reception. This simplifies the process for the driver.

As shown in FIG. 2L, once the driver clicks on the “uploaded” tab, the driver can see a history of his or her successfully submitted BOLs over the course of the last day. Each day the app clears the BOLs from the local cell phone to ensure data security. From this example it can be seen that a BOL was successfully uploaded at 11:02 on the 11, Oct. 2021 and that constituted 1 page. By clicking on the sub-menu on the top right-hand corner of the screen, the driver can also clear their recent upload history. The system has the ability in the back-end software to select a time that is convenient for the client to carry out the daily clean-up of BOLs.

As shown in FIG. 2M, if the driver clicks on the tab detailing the BOL information, the driver can see a thumbnail of the BOL that has been submitted. Multiple thumbnails of BOLs can be made able to be viewed in cases where the driver submits a BOL that includes more than one page.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112(f) unless the words “means for” or “step for” are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method for a user to process a bill of lading (BOL) using a an app on a cell phone that includes a camera and a screen, comprising the steps of:
(a) with the camera, imaging a barcode on the BOL and populating a data box with information from the BOL;
(b) aiming the camera at the BOL;
(c) indicating to the user what the app has determined to be the boundaries of the BOL;
(d) receiving input from the user that the BOL is within the indicated boundaries and that the BOL is within a predetermined range of the camera;
(e) then capturing an image of the BOL and displaying the captured image of the BOL to the user;
(f) upon receiving input from the user indicating that the captured image is acceptable, then passing the image through two passes of a light OCR engine wherein the first pass identifies as many characters on the image as possible and wherein the second pass attempts to identify as many characters as possible, thereby generating a competency score that is captured on the image along with a pro number, a time stamp, driver details and GPS location; and
(g) if the competency score is greater than a set acceptable score then transmitting the image along with a metadata file to a destination cloud-based server, if the competency score is not greater than the set acceptable score then not transmitting the image along with a metadata file to a destination cloud-based server.

2. The method of claim 1, wherein the step of imaging a barcode further comprises the steps of:
(a) aligning the barcode of a centerline displayed on the cell phone;
(b) detecting a PRO number once the barcode has been read; and
(c) populating a box on the screen with the PRO number.

3. The method of claim 2, further comprising the step of receiving manual input of the PRO code on the cell phone from the user when the PRO number is not successfully populated automatically.

4. The method of claim 1, wherein the step of indicating to the user what the app has determined to be the boundaries of the BOL comprises the step of displaying a first image of an augmented reality rectangular border on the cell phone that corresponds to a border image stored by the cell phone that an app on the cell phone has determined to correspond to the BOL.

5. The method of claim 4, further comprising the step of displaying a second image of four corners of a rectangle that ensures that the user is taking an image at an optimum distance from the BOL when the image fits with the second image of four corners.

6. The method of claim 5, wherein the image of the BOL fits with the second image when the BOL is at a distance in a range from 16 in. to 18 in. from the camera.

7. The method of claim 5, further comprising the steps of:
(a) receiving an indication from the user indicating that the user believes that the BOL is at a correct distance and angle from the camera; and
(b) capturing the image on the cell phone when the indication has been received.

8. The method of claim 7, wherein the indication comprises the user having touched at least one of the first image or the second image on the screen.

9. The method of claim 7, further comprising the step of receiving an input from the user indicating how the captured image of the BOL is to be cropped.

10. The method of claim 7, further comprising the step of automatically deskewing the captured image of the BOL is to be cropped.

11. A system for a user to process a bill of lading (BOL), comprising:
(a) a cellular telephone including a screen, a camera and an app, the app programmed to:
(i) with the camera, image a barcode on the BOL and populate a data box with information from the BOL;
(ii) indicate to the user what the app has determined to be the boundaries of the BOL;
(iii) receive input from the user that the BOL is within the indicated boundaries and that the BOL is within a predetermined range of the camera;
(iv) after the input has been received from the user, capture an image of the BOL and display the captured image of the BOL to the user; and
(v) after input has been received from the user indicating that the captured image is acceptable, then analyze the captured image so as to recognize text therein and assign captured text to data fields; and
(b) a cloud-based server to which the data fields are transmitted.

12. The system of claim 11, wherein the app is further programmed to:
(a) align the barcode of a centerline displayed on the cell phone;
(b) detect a PRO number once the barcode has been read; and
(c) populate a box on the screen with the PRO number.

13. The system of claim 12, wherein the app is further programmed to: receive manual input of the PRO code on the cell phone from the user when the PRO number is not successfully populated automatically.

14. The system of claim 11, wherein the app is further programmed to display a first image of an augmented reality rectangular border on the cell phone that corresponds to a border image stored by the cell phone that an app on the cell phone has determined to correspond to the BOL.

15. The system of claim 14, wherein the app is further programmed to display a second image of four corners of a rectangle that ensures that the user is taking an image at an optimum distance from the BOL when the image fits with the second image of four corners.

16. The system of claim 15, wherein the image of the BOL fits with the second image when the BOL is at a distance in a range from 16 in. to 18 in. from the camera.

17. The system of claim 15, wherein the app is further programmed to:
(a) receive an indication from the user indicating that the user believes that the BOL is at a correct distance and angle from the camera; and
(b) capture the image on the cell phone when the indication has been received.

18. The system of claim 17, wherein the indication comprises the user having touched at least one of the first image or the second image on the screen.

19. The system of claim 17, wherein the app is further programmed to receive an input from the user indicating how the captured image of the BOL is to be cropped.

20. The system of claim 17, wherein the app is further programmed to automatically deskew the captured image of the BOL is to be cropped.
